(19) United States
(12) Patent Application Publication
(10) Pub. No.: US 2017/0335776 A1
(43) Pub. Date: Nov. 23, 2017

(54) METHOD OF CONTROLLING A TEST APPARATUS FOR A GAS TURBINE ENGINE AND TEST APPARATUS

(71) Applicant: Nuovo Pignone Srl, Florence (IT)

(72) Inventors: Gianni IANNUZZI, Florence (IT); Davide VAGELLI, Florence (IT); Marco INNOCENTI, Florence (IT); Luca MERIGGIOLI, Florence (IT); Alessandro LENSI, Florence (IT)

(21) Appl. No.: 15/533,783

(22) PCT Filed: Nov. 26, 2015
(86) PCT No.: PCT/EP2015/077765

§ 371 Date: Jun. 7, 2017

(30) Foreign Application Priority Data
Dec. 9, 2014 (IT) CO2014A000038

(51) Int. Cl. F02C 9/40; F02C 3/30; F02C 9/26

(52) U.S. Cl. CPC F02C 9/40; F02C 9/263; F02C 3/30; F05D 2260/82; F05D 2260/83; F05D 2260/12

(57) ABSTRACT

The method allows to control a test apparatus for a gas turbine engine; WI values of one or more tentative fuel gas mixtures are predicted by calculations and the predicted WI values are used for setting the composition of a fuel gas mixture to be supplied to a combustor of a gas turbine engine under test. The test apparatus comprises: a first supply flow line for fuel gas; a second supply flow line for inert gas; a mixer with a first inlet for fuel gas and a second inlet for inert gas, and with an outlet for supplying the mixture of fuel gas and inert gas to the combustor; a set of meters; and a flow control device for the inert gas.

### BACKGROUND

Embodiments of the subject matter disclosed herein correspond to methods of controlling an apparatus used for testing a gas turbine, and to test apparatuses

The fuel, very often natural gas, used in “gas turbine engines”, also referred simply as “gas turbine” or GT, can come from different sources. The performance of a gas turbine depends directly on the characteristics of the fuel. This means that a change in one or more of the characteristics leads to a change in the performance.

Consequently, in the field of “Oil & Gas”, the problem of the interchangeability of natural gas has a considerable importance in the design, installation and operation of gas turbines. Two specific gasses may be considered interchangeable with each other for a specific gas turbine if, when used, the gas turbine provides the same or substantially the same performance.

One parameter usually considered for evaluating fuel gases is their “Wobbe Index” or WI. If two fuel gases have identical WI, then, for given temperature and pressure and valve settings, the combustion energy output will also be identical. For ordinary applications, variations of up to 5% of the WI are accepted.

A gas turbine may be provided with a gas supply equipment which controls variation of WI. For example, a gas turbine system comprising a mixer which adds compressed air to a fuel gas for generating a mixture to be conveyed to a combustor of the system. In such a system, flow meters are provided for adjusting the amount of air and fuel gas injected into the mixer. Such a system also comprises one or two heat exchangers for varying the temperature of air and fuel gas upstream the mixer. A sensor unit is provided downstream the mixer for measuring the real value of the WI. Other sensor units measure pressure, temperature, flow rate of air and fuel gas upstream the mixer. A control unit manages the equipment in order to maintain the WI of the fuel mixture within a predetermined WI range thus avoiding performance variations of the gas turbine; in detail, when the measured WI is outside the predetermined WI range, the control unit acts on the heat exchangers for varying temperature and on the flow meters for varying flow rates.

As a matter of fact, gas supply equipment is very complex and expensive due to the need of keeping the gas turbine (well) operating against unpredictable (slow and/or small) variations in the input fuel gas.

Furthermore, in the field of “Oil & Gas”, there is a need to test gas turbine engines in laboratories; in particular, there is a need to determine how a gas turbine performs when receiving a fuel gas identical to the one available at its installation site (i.e. “site fuel gas”) and/or reacts upon variations in the fuel gas received at its fuel gas inlet (including quick and/or large variations). Anyway, in laboratories, only one source of fuel gas is usually available and it has constant and predetermined characteristics.

These requirements are not fully met by known test apparatuses.

### BRIEF DESCRIPTION OF THE INVENTION

Therefore, there is a general need for a method of controlling a test apparatus for a gas turbine engine, and for a corresponding test apparatus.

In addition to the tests already mentioned, i.e. tests with “site fuel gas” and tests with quick and/or large variations in the input fuel gas, important tests are “stress tests” and “extreme tests” (for example with an input fuel gas having a very low “Lower Heating Value” or LHV).

The parameter of the input fuel gas (i.e. the gas to be provided to a combustor of the engine under test) that is primarily considered for the tests is the “Wobbe Index” or WI.

It is to be noted that accurately and quickly measuring the WI of a fuel gas mixture is very difficult.

In an embodiment it is important to predict (in real time) the WI of tentative fuel gas mixtures by calculations (thus avoiding the measurement of the WI) and to use such predictions for setting the composition of a fuel gas mixture to be supplied to a combustor of the engine under test; the WI of the fuel gas mixture supplied to the combustor is typically (directly or indirectly) decided by a human operator based on e.g. design specifications.

The fuel gas mixture may be obtained from a fuel gas flow (in particular natural gas coming from e.g. a public distribution network) and an inert gas flow (in particular nitrogen coming from e.g. a bottle or cylinder); both the compositions of the fuel gas and the inert gas are known and constant (or substantially constant); in particular, the fuel gas flow is constant (or substantially constant or at least very slowly varying and uncontrolled) and the inert gas flow is set at a value depending on the test to be carried out, i.e. on the WI of the input fuel gas to be tested.

The prediction of the WI may be based on characteristics measured in real time (for example temperature, pressure, volumetric flow of the fuel gas and/or the inert gas) and/or characteristics determined before the operation of the test apparatus (for example composition of the fuel gas and/or the inert gas, characteristics of valves).

In an embodiment it is important to let a control unit (implemented through e.g. a PLC) carry out (in real time) only simple calculations and use tables containing data measured and/or calculated before the operation of the test apparatus. At least some of the complex calculations may be carried (in real time) out by a human machine interface program running on a computer, for example a PC, in communication with the control unit, for example a PLC.

In this way, the WI of the input fuel gas may be set with a high precision, for example 1.00% or 0.50% or 0.25%.

An embodiment of the subject matter disclosed herein relate to a method of controlling a test apparatus for a gas turbine engine.

According to such method, WI values of one or more tentative fuel gas mixtures are predicted by calculations and the predicted WI values are used for setting the composition of a fuel gas mixture to be supplied to a combustor of a gas turbine engine under test.

An embodiment of the subject matter disclosed herein relate to an apparatus for testing a gas turbine engine.

Such apparatus comprises: a first supply flow line in communication with a fuel gas source; a second supply flow line in communication with an inert gas source; a mixer with a first inlet in communication with said first supply line and a second inlet in communication with said second supply line, and with an outlet for supplying a mixture of fuel gas and inert gas to a combustor of the gas turbine engine; first flow meter arranged along said first supply line upstream said mixer; a second flow meter arranged along said second supply line upstream said mixer; a flow control device along said second supply line upstream said mixer.

### BRIEF DESCRIPTION OF DRAWINGS

The accompanying drawings, which are incorporated herein and constitute an integral part of the present specification, illustrate exemplary embodiments of the present invention and, together with the detailed description, explain these embodiments. In the drawings:

FIG. 1 shows a schematic view of an embodiment of a test apparatus; and

FIG. 2 is a flow chart of an embodiment of a control procedure.

### DETAILED DESCRIPTION

The following description of exemplary embodiments refers to the accompanying drawings.

The following description does not limit the invention. Instead, the scope of the invention is defined by the appended claims.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

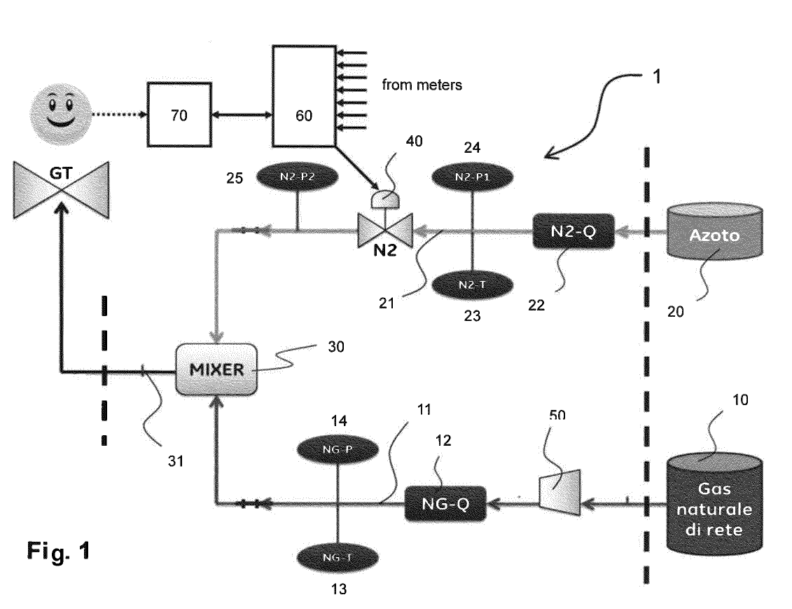

FIG. 1 shows an embodiment of an apparatus 1 for testing a gas turbine engine GT. The test apparatus 1 is connected to a natural gas (NG) source 10 feeding a first supply flow line 11; the source 10 may be a public distribution network. A source 20 of inert gas, for example nitrogen (N2), is provided for feeding a second supply flow line 21 of the test apparatus 1; the source 20 may be a bottle or cylinder. The test apparatus 1 comprises a compressor 50 arranged along the first supply line 11 downstream the source 10. Each supply line 11 and 21 is provided with a gas flow meter 12 and 22 for measuring the volumetric flow of the corresponding gas. In an embodiment, ultrasonic flow meters able to directly provide volumetric flow measure are used. More in details, a first ultrasonic flow meter 12 is arranged along said first supply line 11 downstream the source 10 and the compressor 50, while a second flow meter 22 is arranged along the second supply line 21 downstream the source 20.

The test apparatus 1 comprises further a mixer 30 with a first inlet communicating with said first supply line 11 and a second inlet communicating with said second supply line 21. The mixer 30 is provided to mix the NG flow with the N2 flow so as to obtain a mixture at its outlet 31 that is connected to a combustor of the gas turbine GT.

The test apparatus 1 comprises further a flow control device 40 arranged along the second supply line 21 downstream said second flow meter 22 and upstream said mixer 30. The flow control device 40 typically consists of a flow control valve 40 electrically controlled and used for regulating the inert gas flow directed to the second inlet of the mixer 30.

As it appears from FIG. 1, the test apparatus 1 comprises only one flow control device; this is used for the inert gas flow; in particular, no flow control device is provided for the fuel gas flow; in other words, the fuel gas flow is unregulated.

The test apparatus 1 comprises further one or more of a set of meters for best performance of the apparatus: a first temperature meter 13 arranged along said first supply line 11 just upstream said mixer 30; a first pressure meter 14 arranged along said first supply line 11 just upstream said mixer 30; a second temperature meter 23 arranged along said second supply line 21 just upstream said mixer 30; a second pressure meter 24 arranged along said second supply line 21 upstream said mixer 30 and just upstream said flow control device 40; a third pressure meter 25 arranged along said second supply line 21 just downstream said flow control device 40.

Even if not shown in FIG. 1, a temperature meter may be provided at the outlet 31 of the mixer 30.

The test apparatus 1 comprising further a control unit 60 electrically connected to said flow control device 40 in order to send control signals and to the meters, at least to meters 12 and 22, in order to receive measuring signals.

In addition to the control unit 60, a computer 70 may be provided in communication with the control unit 60; the control unit 60 is, in an embodiment, a PLC and/or the computer 70 is, in an embodiment, a PC. The computer 70 typically runs a human-machine interface program for receiving input from a human operator and transmitting output to the human operator.

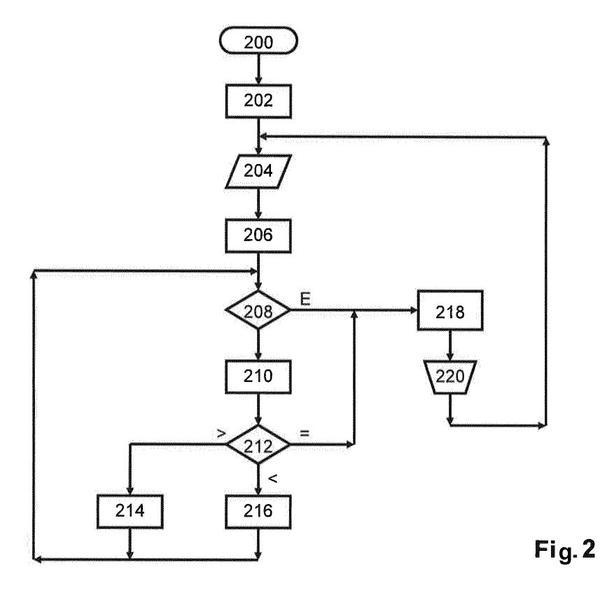

The operation of the test apparatus 1 will be described in the following with the aid of FIG. 2, in particular a method of controlling it for carrying out tests on a gas turbine engine hydraulically connected to the outlet 31 of the mixer 30.

FIG. 2 is a flow chart of an embodiment of a control procedure; the start of the procedure corresponds to block 200; no end of the procedure is not shown in FIG. 2 in the assumption that the procedure permanently loops till the test apparatus is stopped.

In general, it is reasonable to consider that the inert gas, for example nitrogen, is pure (i.e. with negligible impurities) and that its LHV and its WI is null.

In general, it is reasonable to consider that the fuel gas, for example natural gas, has a constant composition and has a constant LHV; in this case, composition and LHV should be known to the test apparatus. If the composition of the fuel gas (slowly) vary, it is necessary to determine it through e.g. a gas chromatograph, to determine or calculate its LHV, and to provide such information to the test apparatus; if the gas chromatograph is a component of the test apparatus, the LHV of the natural gas may be calculated by the computer 70 or by the control unit 60 based on the composition information received from the gas chromatograph (or input by a human operator).

Such initial operations correspond to block 202.

Based on the values detected by the meters of the apparatus of FIG. 1, it is possible to calculate, i.e. predict, the WI value of the fuel gas mixture supplied through the outlet 31 of the mixer 30 to the combustor of the gas turbine GT engine under test.

When a different WI value is desired, the flow control device 40 has to be differently adjusted by the control unit 60, i.e. a different “open percentage” or “open level” is to be set.

The desired WI value may be provided by a human operator to the computer 70 that forwards it to the control unit 60; alternatively, for example, the human operator provides a desired WI value variation to the computer 70 that generates a corresponding sequence of desired WI values and transmits them to the control unit 60 in appropriate succession.

Such input of the desired WI value corresponds to block 204.

According to an embodiment, the “open percentage” or “open level” of the valve 40 is determined through iterations or successive approximations. In an embodiment, a “binary search” algorithm is used.

In a first attempt (i.e. first iteration), the current mass flow of nitrogen is assumed at 50% of the maximum mass flow of nitrogen; such initial setting corresponds to block 206.

Based on this assumption and the values detected by the meters, a current predicted WI value is calculated; such calculation corresponds to block 210.

If the difference between the desired WI value and the current predicted WI value is lower than a predetermined threshold, in particular 0.5%, the current mass flow of nitrogen is the desired one; this corresponds to exit “=” of block 212.

If the desired WI value is more than the current predicted WI value, the current mass flow of nitrogen must be reduced; this corresponds to exit “>” of block 212. If a “binary search” algorithm is used, the reduction is of 50%; this correspond to block 214.

If the desired WI value is less than the current predicted WI value, the current mass flow of nitrogen must be increased; this corresponds to exit “>” of block 212. If a “binary search” algorithm is used, the increase is of 50%; this correspond to block 216.

Based on the new current mass flow of nitrogen, i.e. the increased or decreased mass flow, (next attempt) (flow control returns back as shown on the left side of FIG. 2) and the values detected by the meters, a new current predicted WI value is calculated (block 210).

The iterative procedure (i.e. sequence of attempts) is continued until when the difference between the desired WI value and the current predicted WI value is lower than a predetermined threshold, in particular 0.5% (block 210); as a safety measure, the iterative procedure is stopped also in case the number of iterations carried exceeds a predetermined threshold, in particular 20 (block 208).

Based on the calculated desired mass flow of nitrogen, values detected by the meters and the characteristics of valve 40, its desired “open percentage” or “open level” is to calculated; this correspond to block 218;

Only now the valve 40 is set accordingly by the control unit 60; this correspond to block 220.

A new desired WI may be input manually or automatically) (flow control returns back as shown on the right side of FIG. 2).

In view of what has just been described, according to a method of controlling the test apparatus 1, WI values of one or more tentative fuel gas mixtures are predicted by calculations and the predicted WI values are used for setting the composition of a fuel gas mixture to be supplied to a combustor of a gas turbine engine under test.

The supplied fuel gas mixture is obtained by mixing a fuel gas flow and an inert gas flow, and the inert gas flow is set at a value depending on the desired WI value through the flow control device 40. In particular, the inert gas flow is set at a value depending also on the pressure upstream the flow control device 40 and/or pressure drop across the flow control device 40.

As the fuel gas coming from a public distribution network is at a relatively low pressure, it is advantageous in an embodiment that the fuel gas flow is received at an inlet of the test apparatus 1 and compressed by the compressor 50. In particular, the fuel gas flow is not regulated by a flow control device; it may be said that it is unregulated.

Typically, the fuel gas flow is measured (in real time) by the first flow meter 12 and/or the inert gas flow is measured (in real time) by the second flow meter 22. In an embodiment, the first and/or the second flow meters are ultrasonic flow meters providing (directly) volumetric flow measures.

The WI value predictions are based on characteristics measured in real time and/or characteristics determined before operation of the test apparatus.

The measured characteristics may be temperature and/or pressure and/or volumetric flow of the fuel gas and/or the inert gas, and/or pressure drop across the flow control device.

The determined characteristics may be composition of the fuel gas and/or the inert gas and/or LHV and/or molecular weight of the fuel gas and/or characteristics of valves of the test apparatus.

WI value predictions may be based on tables containing data measured and/or calculated before operation of the test apparatus.

WI value predictions may be based directly on data tables or on polynomial formulas obtained from said tables before operation of the test apparatus.

The control unit 60 may be used for carrying out (in real time) simple calculations for WI value predictions and the computer 70 may be used for carrying out (in real time) complex calculations for WI value predictions; the control unit 60 and the computer 70 may exchange results of the carried out calculations.

The complex calculations may be carried out through a human machine interface program running on the computer 70.

When communication between the control unit 60 and the computer 70 does not occur and/or when the computer 70 does not carry out some calculations necessary for WI value predictions, it may be provided that the control unit 60 carries out (in real time) autonomously such calculations; in this case, such calculations are carried out in a simplified (even if less accurate) way, for example through data tables or polynomial

This written description uses examples to disclose the invention, including the preferred embodiments, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A method of controlling a test apparatus for a gas turbine engine, the method comprising:
predicting, by calculation, wobbe index values of one or more tentative fuel gas mixtures; and
using the predicted wobbe index values for setting the composition of a fuel gas mixture to be supplied to a combustor of a gas turbine engine under test.

2. The method of claim 1, wherein the predicted wobbe index values are compared to a desired wobbe index value.

3. The method of claim 2, wherein the difference between the desired wobbe index value and the predicted wobbe index value of the supplied fuel gas mixture is lower than a predetermined threshold.

4. The method of claim 1, wherein the supplied fuel gas mixture is obtained by mixing a fuel gas flow and an inert gas flow, wherein the inert gas flow is set at a value depending on the desired wobbe index value through a flow control device.

5. The method of claim 4, wherein the fuel gas flow is received at an inlet of the test apparatus and compressed by a compressor.

6. The method of claim 4, wherein the fuel gas flow is measured by a first flow meter and/or wherein the inert gas flow is measured by a second flow meter.

7. The method of claim 6, wherein the first or second flow meters are ultrasonic flow meters providing volumetric flow measures.

8. The method of claim 1, wherein wobbe index value predictions are based on characteristics measured in real time or characteristics determined before operation of the test apparatus.

9. The method of claim 8, wherein wobbe index value predictions are based on tables containing data measured or calculated before operation of the test apparatus.

10. The method of claim 1, wherein a control unit is used for carrying out simple calculations for the wobbe index value predictions and a computer is used for carrying out complex calculations for the wobbe index value predictions, wherein the control unit and the computer exchanges results of the carried out calculations.

11. An apparatus for testing a gas turbine engine comprising:
a first supply flow line in communication with a fuel gas source;
a second supply flow line in communication with an inert gas source;
a mixer comprising a first inlet in communication with the first supply line and a second inlet in communication with the second supply line, and further comprising an outlet for supplying a mixture of fuel gas and inert gas to a combustor of the gas turbine engine;
first flow meter arranged along the first supply line upstream the mixer;
a second flow meter arranged along the second supply line upstream the mixer;
a flow control device along the second supply line upstream the mixer.

12. The apparatus of claim 11, wherein wobbe index values of one or more tentative fuel gas mixtures are predicted by calculations and the predicted wobbe index values are used for setting the composition of the fuel gas mixture to be supplied to the combustor of the gas turbine engine under test.

13. The apparatus of claim 10, comprising a control unit and a computer in communication with each other, wherein the control unit is electrically and operatively connected to the flow control device.
